(19) United States
(12) Patent Application Publication
(10) Pub. No.: US 2013/0222930 A1
(43) Pub. Date: Aug. 29, 2013

(54) DRIVING BODY AND DRIVING DEVICE FOR COMPACT CAMERA USING PIEZOELECTRIC ELEMENT

(71) Applicants: He Won Jung, Ansan-si (KR); Jong Sik Seo, Ansan-si (KR); Min Gi Kim, Ansan-si (KR); Se Jun Chun, Ansan-si (KR)

(72) Inventors: He Won Jung, Ansan-si (KR); Jong Sik Seo, Ansan-si (KR); Min Gi Kim, Ansan-si (KR); Se Jun Chun, Ansan-si (KR)

(73) Assignee: HYSONIC. CO., LTD., Ansan-si (KR)

(21) Appl. No.: 13/881,887

(22) PCT Filed: Oct. 25, 2011
(86) PCT No.: PCT/KR11/07990

§ 371 Date: Apr. 26, 2013

(30) Foreign Application Priority Data
Nov. 19, 2010 (KR) 10-2010-0115821
Nov. 19, 2010 (KR) 10-2010-0115837

(51) Int. Cl. H02N 2/00; G02B 7/04

(52) U.S. Cl. CPC H02N 2/001; G02B 7/04
USPC 359/824; 310/323.02

(57) ABSTRACT

The present invention relates to a driving body and a driving device having a piezoelectric element mounted thereon, and more particularly, to a driving body and a driving device having a piezoelectric element mounted thereon for transferring a lens by actuating a lens holder in a vertical direction using the piezoelectric element.

### TECHNICAL FIELD

The present invention relates to a driving body and a driving device having a piezoelectric element mounted thereon, and more particularly to a driving body and a driving device having a piezoelectric element mounted thereon, which moves a lens by actuating a lens holder in a vertical direction using the piezoelectric element.

### BACKGROUND ART

In general, a small communication device such as a portable mobile device is provided with a compact camera.

FIG. 1 is a cross-sectional view of a conventional VCM type compact camera, and FIG. 2 is a cross-sectional view showing a using state of the compact camera of FIG. 1.

As shown in FIGS. 1 and 2, the compact camera includes a lens group 500 consisting of a plurality of lenses for focus regulation and scaling of an object, a lens holder 550 in which the lens group 500 is installed so as to be actuated in an optical axial direction, a fixing part 600, a flat spring 650 which is supported by the fixing part 600 so as to lift up the lens holder 550 so that the lens holder 550 can be moved in the optical axial direction and also to guide the lens holder 550 so that the lens holder can be actuated precisely in the optical axial direction, an actuator which is supported by the lens holder 550 so as to actuate the fixing part 600 in the optical axial direction, an image sensor 800 for taking an image of an object passing through the lens group 500, and a control part for controlling the actuator and the image sensor 800.

The flat spring 650 is formed so that a width between a portion thereof fixed to the fixing part 600 and a portion thereof fixed to the lens holder 550 becomes narrow and thus deformation thereof can be facilely achieved in the optical axial direction.

Therefore, the flat spring 650 elastically supports the lens holder 550 so that the lens holder 550 can be moved in the optical axial direction.

Further, the flat spring 650 is fixed to four or more points of the lens holder 650 and functions as a guide that prevents the lens holder 560 from being moved in a direction orthogonal to the optical axial direction.

Meanwhile, the actuator includes a magnet 710 which is fixed to the fixing part 600, and a coil 720 which is fixed to the lens holder 550 so as to receive magnetic flux from the magnet 710 when power is supplied from the control part and then generate force for actuating the lens holder in the optical axial direction.

Such structure of the actuator is called “VCM type”.

The magnet 710 and the coil 720 are provided in pair so as to be symmetric with each other.

Further, the actuator has a yoke 730 for efficiently circulating the magnetic flux of the magnet 710.

In the above-mentioned compact camera, as shown in FIG. 2, when electric power is applied to the coil 720 of the actuator, electromagnetic force which moves the coil 720 in the optical axial direction is generated by the influence of the magnetic flux from the magnet 710.

Therefore, the fixing part 600 to which the coil 720 is fixed is moved in the optical axial direction.

Accordingly, the control part lifts up or down the lens group 500 in the optical axial direction and thus adapts the image picked up on the image sensor 800 to be clear.

If this VCM type lens holder has a small size or a light weight, it can be actuated well. However, if the lens holder has a large size of a heavy weight, it cannot be actuated well due to its low actuation force.

Further, since VCM type is not strong enough, many defective products may occur upon a drop test. And since the lens holder is moved shortly, it is difficult to use a camera having a high-pixel sensor.

### DISCLOSURE

### Technical Problem

An object of the present invention is to provide a driving body and a driving device having a piezoelectric element mounted thereon, which are actuated well even if a lens holder has a heavy weight, stronger than a VCM type and also can use a camera having a high-pixel sensor due to long moving distance of the lens holder.

### Technical Solution

To achieve the object of the present invention, the present invention can provide a driving body having a piezoelectric element mounted thereon, comprising a resonance part; a first piezoelectric element and a second piezoelectric element which are coupled with the resonance part so as to actuate the resonance part; a first positive electrode and a second GND electrode of which one is coupled to one surface of the first piezoelectric element between the first piezoelectric element and the resonance part and the other one is coupled to the other surface of the first piezoelectric element; and a second positive electrode and a second GND electrode of which one is coupled to one surface of the second piezoelectric element between the second piezoelectric element and the resonance part and the other one is coupled to the other surface of the second piezoelectric element, wherein alternate voltage of a proper frequency having a phase difference is applied to each of the first and second positive electrodes so as to driving the resonance part, and the resonance part comprises a first piezoelectric element coupling part in which the first piezoelectric element is installed; a second piezoelectric element coupling part in which the second piezoelectric element is installed; and an actuating part of which one end is connected to the first piezoelectric element coupling part, the other end is connected to the second piezoelectric element coupling part and a center portion performs an oval displacement motion by the first and second piezoelectric elements, and the first and second piezoelectric element coupling parts are inclinedly formed so as to be gradually close to each other toward the actuating part, and the first and second piezoelectric elements are inclinedly installed at the first and second piezoelectric element coupling parts so as to be gradually close to each other toward the actuating part.

Preferably, when the alternate voltage of the proper frequency is applied, the first and second piezoelectric element coupling parts are contracted and expanded by the first and second piezoelectric elements so as to have a phase difference in a length direction of the resonance part, such that the actuating part of the resonance part performs the oval displacement motion, and the first and second piezoelectric element coupling parts are formed into a flat surface shape which has a wide width in a direction orthogonal to a contracting and expanding direction thereof, and the first piezoelectric element is installed at one of upper and lower surfaces of the first and second piezoelectric element coupling parts having the wide width, and the second piezoelectric element is installed at one of the upper and lower surfaces of the first and second piezoelectric element coupling parts having the wide width.

Preferably, a connecting part is formed between the first and second piezoelectric element coupling parts so as to connect the first and second piezoelectric element coupling parts, and the first and second piezoelectric element coupling parts are symmetric with respect to an extension line between the actuating part and the connecting part.

Preferably, the proper frequency of the alternate voltage applied to the first and second positive electrodes is a value between a first resonance frequency by which the actuating part is reciprocated in a length direction of the resonance part and a second resonance frequency by which the actuating part performs a curvature movement in a direction vertical to the length direction of the resonance part.

Preferably, the second resonance frequency has a value between the first resonance frequency and a first anti-resonance frequency.

Further, the present invention provides a driving device for a compact camera using a piezoelectric element, comprising a base member; a lens holder which is disposed in the base member and in which a lens is installed to be driven in an optical axial direction; a driving body which drives the lens holder in the optical axial direction; and a control part which controls the driving body, wherein the driving body comprises a resonance part which is slidably disposed at a side surface of the base member and of which one end is contacted with an outer circumferential surface of the lens holder; a first piezoelectric element and a second piezoelectric element which are coupled with the resonance part so as to actuate the resonance part; a first positive electrode and a first GND electrode of which one is coupled to one surface of the first piezoelectric element between the first piezoelectric element and the resonance part and the other one is coupled to the other surface of the first piezoelectric element; and a second positive electrode and a second GND electrode of which one is coupled to one surface of the second piezoelectric element between the second piezoelectric element and the resonance part and the other one is coupled to the other surface of the second piezoelectric element, and

the resonance part comprises a first piezoelectric element coupling part in which the first piezoelectric element is installed; a second piezoelectric element coupling part in which the second piezoelectric element is installed; and an actuating part of which one end is connected to the first piezoelectric element coupling part, the other end is connected to the second piezoelectric element coupling part and a center portion is contacted with the outer circumferential surface of the lens holder, and

the control part applies alternate voltage having a frequency corresponding to a resonance frequency of the driving body and having a phase difference to each of the first and second positive electrodes, and

the actuating part is reciprocated in a length direction by alternate voltage of a first resonance frequency applied to the first and second piezoelectric elements and also performs a curvature movement in a direction vertical to the length direction by a second resonance frequency applied to the first and second piezoelectric elements, and

the control part applies alternate voltage having a proper frequency between the first and second resonance frequencies to the first and second piezoelectric elements, such that a center portion of the actuating part performs an oval motion and also drives the lens holder in an optical axial direction, and the first and second piezoelectric element coupling parts are inclinedly formed so as to be gradually close to each other toward the actuating part, and the first and second piezoelectric elements are inclinedly installed at the first and second piezoelectric element coupling parts so as to be gradually close to each other toward the actuating part.

Preferably, the first and second piezoelectric element coupling parts are formed into a flat surface shape which has a wide width in a direction vertical to a moving direction of the lens holder, and the first piezoelectric element is installed at one of upper and lower surfaces of the first piezoelectric element coupling part having the wide width, and the second piezoelectric element is installed at one of the upper and lower surfaces of the second piezoelectric element coupling part having the wide width.

Preferably, the driving device further comprises a slider which is installed at the base member so as to be slid toward the outer circumferential surface of the lens holder; and an elastic member which elastically supports the slider toward the outer circumferential surface of the lens holder, wherein the resonance part is installed at the slider so as to move the actuating part, so that the actuating part is contacted with the outer circumferential surface of the lens holder.

Preferably, a connecting part is formed between the first and second piezoelectric element coupling parts so as to connect the first and second piezoelectric element coupling parts, and a fixing protrusion which is fixedly inserted into the connecting part is formed at the slider.

Preferably, the connecting part is disposed between the first and second piezoelectric element coupling parts and comprises a center portion in which the fixing protrusion is fixedly inserted; an extended portion which is protruded from the center portion to the first and second piezoelectric element coupling parts so as to be integrally connected with the first and second piezoelectric element coupling parts, and a thickness of the extended portion in a moving direction of the slider is thinner than that of the center portion.

Preferably, the first and second piezoelectric element coupling parts are symmetric with respect to an extension line between the actuating part and the connecting part.

Preferably, guide rails are formed at a side surface of the base member so as to be spaced apart from each other upward and downward, and guide grooves are formed in the guide rails so as to be oppositely opened, and a guide protrusion is formed at upper and lower ends of the slider to be bent in a direction orthogonal to the moving direction of the lens holder, and the guide protrusion is inserted into the guide grooves.

Preferably, a first supporting part is formed at an opposite side of the actuating part with the connecting part in the center so as to be protruded from the side surface of the base member, and a second supporting part of which one end is contacted with the connecting part is formed at the slider so as to be protruded between the first supporting part and the connecting part, and the elastic member is disposed between the first and second supporting parts so as to elastically support the slider toward the outer circumferential surface of the lens holder.

Preferably, a first guide shaft is formed at the first supporting part so as to be protruded to the second supporting part, and a second guide shaft is formed at the other end of the second supporting part so as to be protruded to the first supporting part, and the elastic member is disposed to cover the first and second guide shafts.

Preferably, a contacting part is formed at the outer circumferential surface of the lens holder so as to be protruded toward the actuating part, and a friction member is formed at a center portion of the actuating part so as to be protruded in an opposite direction of the first and second piezoelectric elements, and a sub-friction part contacted with the friction member is installed at the contacting part.

Preferably, a movement guide member is disposed between the base member and the lens holder so as to smoothly move the lens holder up and down, and the movement guide member comprises a retainer which is disposed between the base member and the lens holder, and a ball member which is rotatably inserted into the retainer so as to be contacted with the side part and the lens holder.

### Advantageous Effects

As described above, the driving body and the driving device having the piezoelectric element mounted thereon of the present invention have the effects as follows:

Since the first and second piezoelectric element coupling parts are formed inclinedly to be gradually close to each other toward the actuating part, the driving force of the driving body is enhanced and thus the lens holder can be facilely actuated even when the lens holder has a heavy weight, and also since the moving distance is increased, it is possible to use a camera having a high-pixel sensor.

Since the first piezoelectric element coupling part and the second piezoelectric element coupling part are respectively formed into a flat shape which has a wider width in the direction orthogonal to the contracting and expanding direction thereof, it is possible to facilely machine the resonance part, thereby improving the productivity and the assemblability.

Since the connecting part is disposed on the center line between the first and second piezoelectric element coupling parts, the first and second piezoelectric element coupling parts are operated in balance.

Since the proper frequency between the first and second resonance frequencies is applied to the first and second positive electrodes, the actuating part performs the oval motion by composition of the length directional motion and the up and down motion.

Since the resonance part is fixed to the slider so as to support the actuating part toward the outer circumferential surface of the lens holder, the actuating part is closely contacted with the outer circumferential surface of the lens holder, thereby increasing power transmissibility.

Since the connecting part is fixed to the slider through the fixing protrusion, it is possible to facilely assemble the resonance part.

Since the connecting part for connecting the center portion and the first and second piezoelectric element coupling parts is formed to be thin, it is minimized that the contracting and expanding of the first and second piezoelectric element coupling parts are disturbed by the center portion.

Since the guide protrusion is inserted into the guide groove, the slider is guided so as to be slide on the side surface of the base member and also prevented from being moved in the direction orthogonal to the moving direction of the lens holder.

Since the guide protrusion is formed to be bent in the direction orthogonal to the moving direction of the lens holder, the strength of the slider is enhanced and the bending deformation thereof is prevented.

Since one end of the second supporting part is surface-contacted with the connecting part and the other end thereof is contacted with the elastic member, the elastic force of the elastic member is smoothly transmitted to the slider, and it is prevented that the connecting part is rotated or shaken.

Since the elastic member is disposed to cover the first and second guide shafts, it is prevented that the elastic member is kept between the first and second supporting parts.

Since the sub-friction part is installed at the contacting part and the friction member contacted with the sub-friction part is installed at the center portion, the friction force between the lens holder and the actuating part is increased, and thus the driving force of the actuating part can be smoothly transmitted to the lens holder.

Since the movement guide member having the ball member which is independently rotated is installed between the base member and the lens holder, the friction between the base member and the lens holder is reduced and thus the lens holder can be smoothly moved up and down.

### DESCRIPTION OF DRAWINGS

The above and other objects, features and advantages of the present invention will become apparent from the following description of preferred embodiments given in conjunction with the accompanying drawings, in which:

FIG. 1 is a cross-sectional view of a conventional VCM type compact camera.

FIG. 2 is a cross-sectional view showing a using state of the compact camera of FIG. 1.

FIG. 3 is a perspective view of a compact camera driving device according to an embodiment of the present invention.

FIG. 4 is a front view of FIG. 3.

FIG. 5 is a plane view of FIG. 3.

FIG. 6 is a partially exploded perspective view of the compact camera driving device according to the embodiment of the present invention.

FIG. 7 is an exploded perspective view of a slider, an elastic member and a driving body in FIG. 6.

FIG. 8 is a view showing an actuation state of the driving body in a first resonance frequency according to the embodiment of the present invention.

FIG. 9 is a view showing an actuation state of the driving body in a second resonance frequency according to the embodiment of the present invention.

FIG. 10 is a view showing an elliptical motion state of an actuating part of the driving body in a proper resonance frequency according to the embodiment of the present invention.

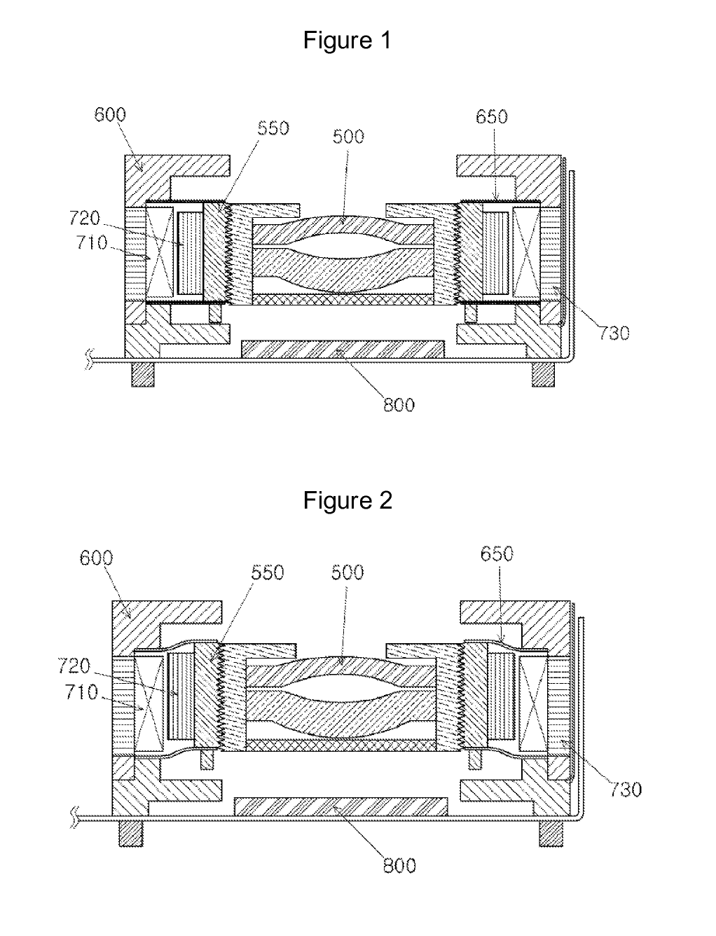

### BEST MODE

Hereinafter, the embodiments of the present invention will be described in detail with reference to accompanying drawings.

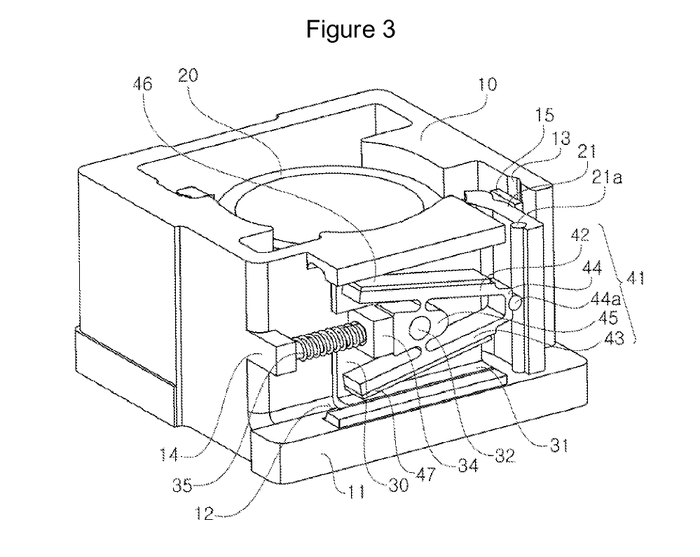

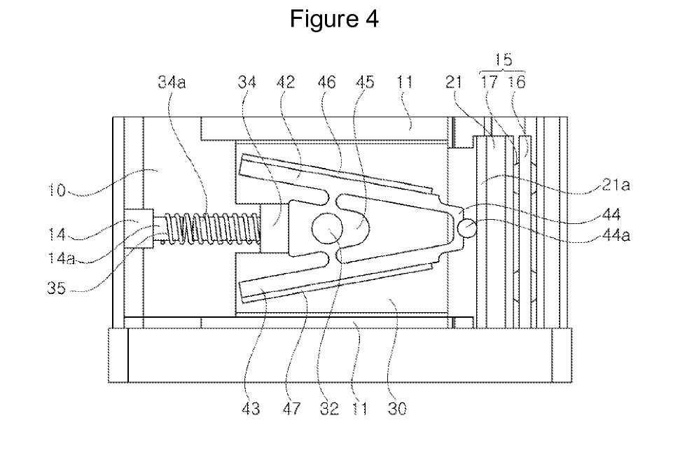

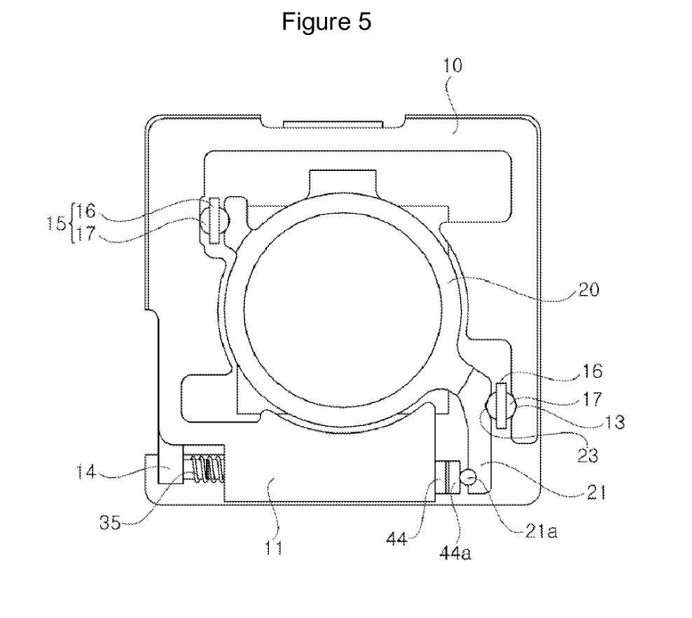

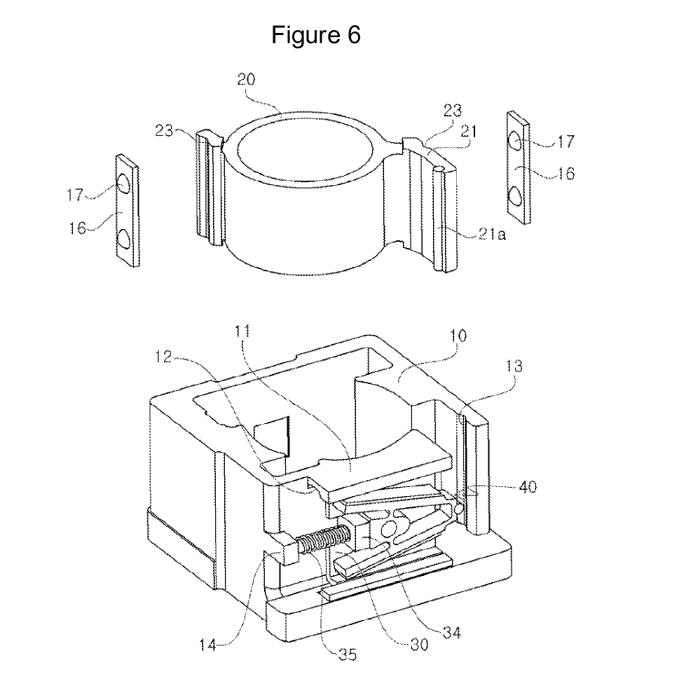

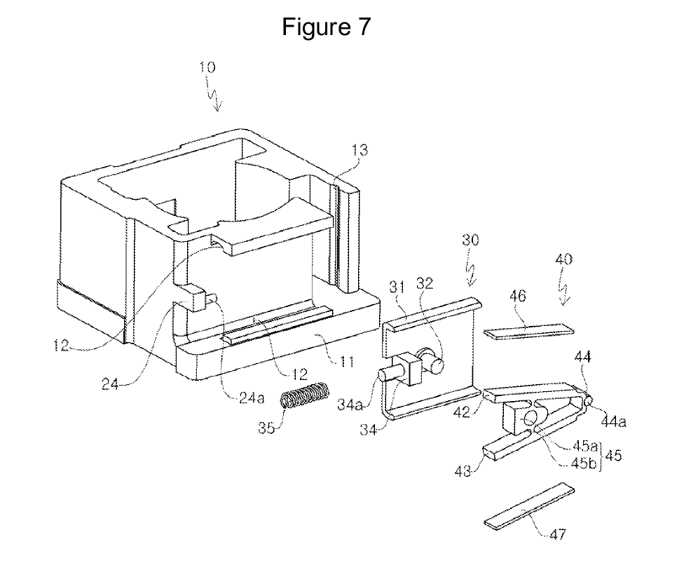

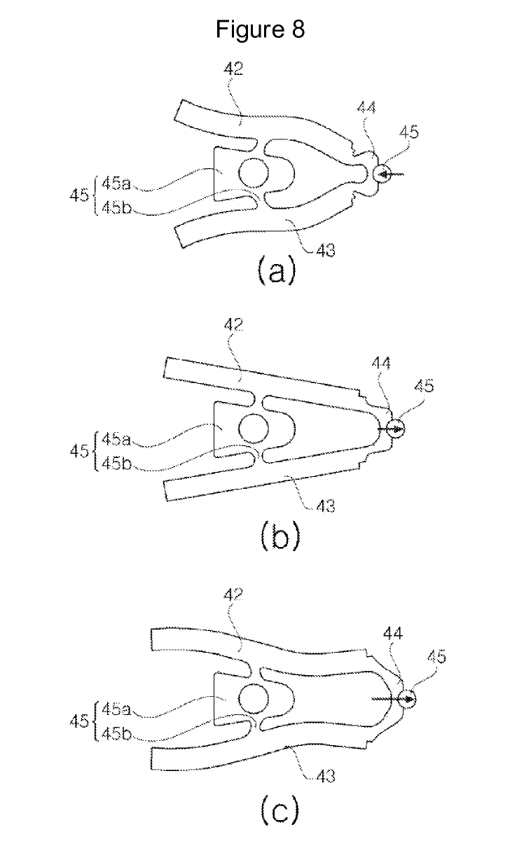

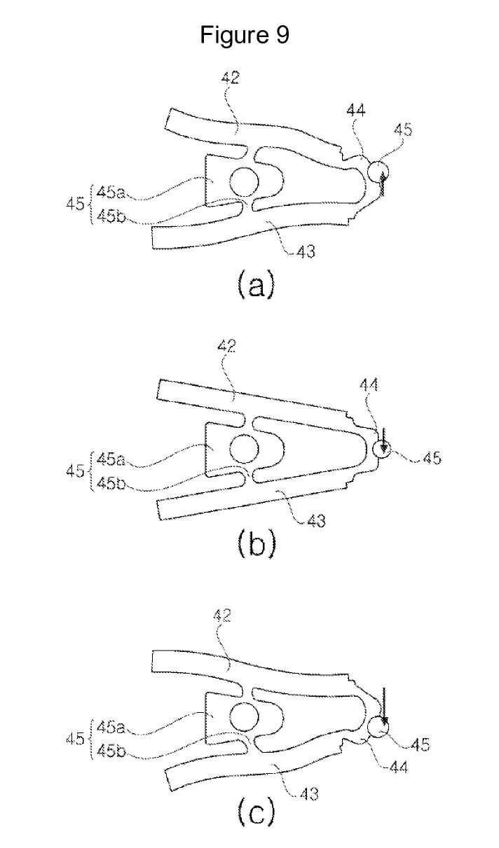

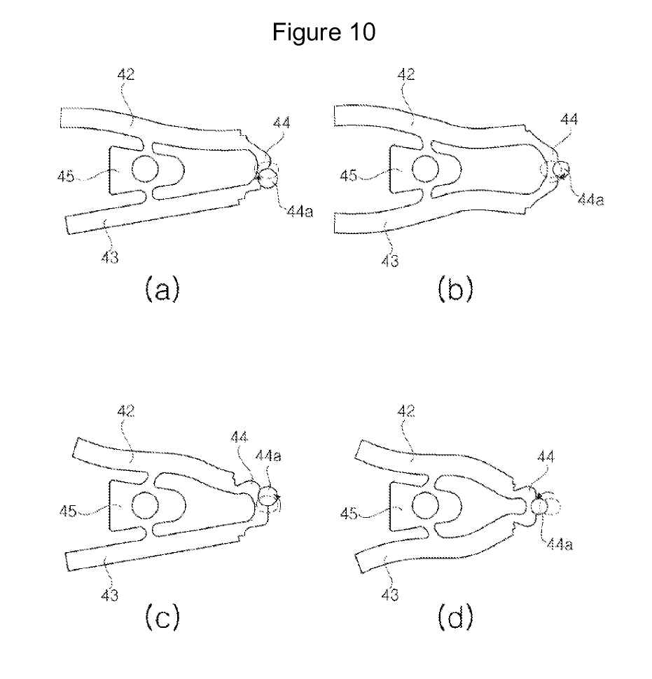

FIG. 3 is a perspective view of a compact camera driving device according to an embodiment of the present invention, FIG. 4 is a front view of FIG. 3, FIG. 5 is a plane view of FIG. 3, FIG. 6 is a partially exploded perspective view of the compact camera driving device according to the embodiment of the present invention, FIG. 7 is an exploded perspective view of a slider, an elastic member and a driving body in FIG. 6, FIG. 8 is a view showing an actuation state of the driving body in a first resonance frequency according to the embodiment of the present invention, FIG. 9 is a view showing an actuation state of the driving body in a second resonance frequency according to the embodiment of the present invention, and FIG. 10 is a view showing an elliptical motion state of an actuating part of the driving body in a proper resonance frequency according to the embodiment of the present invention.

As shown in FIGS. 3 to 10, a compact camera driving device using a piezoelectric element according to the present invention includes a base member 10, a lens holder 20, a slider 30, an elastic member, a driving body 40 and a control part.

The base member 10 is formed into a hexahedral shape of which upper and lower portions are opened and in which the lens holder 20 is installed so as to be movable up and down and also that an image sensor (not shown) or the like is disposed at a lower side thereof

Further, guide rails 11 are formed at an outer surface of the base member 10 so as to be spaced part from each other upward and downward.

The guide rails 11 are respectively formed into a square shape which is protruded in a direction orthogonal to a moving direction of the lens holder 20.

Guide grooves 12 are formed in the guide rails 11 so as to be oppositely opened.

The guide grooves 12 are formed to be recessed in a direction far away from each other, and the slider 30 is disposed between the guide grooves 12.

The lens holder 20 is formed into cylindrical shape of which the upper and lower portions are opened and in which the lens (not shown) is installed so as to be movable up and down, i.e., in the optical axial direction.

A contacting part 21 is formed at an outer circumferential surface of the lens holder 20 so as to be protruded toward an actuating part 44 of the driving body 40.

The contacting part 21 is formed into a square shape which is disposed to be passed through the outer surface of the base member 10 that the guide rails 11 are formed.

Further, a sub-friction part 21a contacted with a friction member 44a of the driving body 40 is installed at the contacting part 21, as described later.

The sub-friction part 21a is formed into a cylindrical shape which is formed to be extended upward and downward, i.e., in a moving direction of the lens holder 20.

A movement guide member 15 is disposed between the base member 10 and the lens holder 20 in order to facilely move the lens holder 20 up and down.

As shown in FIGS. 4 and 5, the movement guide member 15 is comprised of a retainer 16 and a ball member 17.

The retainer 16 is formed into a square shape which is extended upward and downward so as to be disposed between an inner side surface of the base member 10 and the outer circumferential surface of the lens holder 20 but not contacted with the inner side surface of the base member 10 and the outer circumferential surface of the lens holder 20.

The ball member 17 is formed into a sphere shape which is rotatably inserted into the retainer 16.

Further, two ball members 17 are installed in the retainer 16 to be spaced apart from each other and also contacted with the inner side surface of the base member 10 and the outer circumferential surface of the lens holder 20.

That is, a diameter of the ball member 17 is larger than a thickness of the retainer 16, and thus the ball member 17 is protruded to an outside of the retainer 16 and contacted with the inner side surface of the base member 10 and the outer circumferential surface of the lens holder 20. However, the retainer 16 is not contacted with the inner side surface of the base member 10 and the outer circumferential surface of the lens holder 20.

Further, a rail groove 13, 23 in which the ball member 17 is received and moved is formed in the inner side surface of the base member 10 and the outer circumferential surface of the lens holder 20 so as to be extended upward and downward.

The retainer 16 moves only a half of a moving distance of the lens holder 20 when the lens holder 20 is moved up and down.

Due to the movement guide member 15 having the ball member 17 which is disposed between the base member 10 and the lens holder 20 so as to be independently rotatable, the friction between the inner side surface of the base member 10 and the outer circumferential surface of the lens holder 20 is reduced and thus the lens holder can be facilely moved up and down.

The slider 30 is disposed at the outer side surface of the base member 10 so as to be slid toward the outer circumferential surface of the lens holder 20, i.e., the contacting part 21.

More detailedly, the slider 30 is formed into a flat plate shape which is formed to be wider in the moving direction of the lens holder 20 and also disposed between the guide grooves 12 so as to be slide toward the contacting part 21.

Further, a guide protrusion 31 is formed at upper and lower ends of the slider 30 to be bent in a direction orthogonal to the moving direction of the lens holder 20.

The guide protrusion 31 is formed into a square shape which is formed to be bent in a protruded direction of the guide rail 11 and then inserted into the guide groove 12.

Since the guide protrusion 31 is inserted into the guide groove 12, the slider 30 is guided so as to be slide on the side surface of the base member 10 and also prevented from being moved in the direction orthogonal to the moving direction of the lens holder 20.

Further, since the guide protrusion 31 is formed to be bent in the direction orthogonal to the moving direction of the lens holder 20, the strength of the slider 30 is increased and thus it is prevented the slider 30 is bent.

And the slider 30 is elastically supported toward the outer circumferential surface of the lens holder 20, i.e., the contacting part 21 by an elastic member.

The elastic member is a coil spring. One end of the elastic member is contacted with a first supporting part 14 formed at the side surface of the base member 10 and the other end thereof is contacted with a second supporting part 34 formed at the slider 30 so as to support the slider 30 toward the outer circumferential surface of the lens holder 20, i.e., the contacting part 21.

The first supporting part 14 is formed at the outer surface of the base member 10 having the guide rail 11 so as to be protruded in the direction orthogonal to the moving direction of the lens holder 20 and disposed to be opposed to the contacting part 21.

That is, the first supporting part 14 is disposed at an opposite side of the actuating part 44 with a connecting part 45 of a resonance part 41 in the center, as described later.

The second supporting part 34 is formed at the slider 30 so as to be protruded in the direction orthogonal to the moving direction of the lens holder 20 and disposed between the first supporting part 14 and the connecting part 45 of the resonance part 41 installed at the slider 30.

One end of the second supporting part 34 is formed into a flat shape so as to be surface-contacted with the first supporting part 14 and the connecting part 45, as described later, and the other end thereof is contacted with the elastic member.

As described above, since one end of the second supporting part 34 is surface-contacted with the first supporting part 14 and the connecting part 45, the elastic force of the elastic member is facilely transmitted to the slider 30, and also it is prevented that the connecting part 45 is rotated or shaken.

Further, a first guide shaft 14a is formed at the first supporting part 14 so as to be protruded toward the second supporting part 34, and a second guide shaft 34a is formed at the other end of the supporting part 34 so as to be protruded toward the first supporting part 14.

The elastic member is disposed between the first and second supporting parts 14 and 34 so as to cover the first and second guide shafts 14a and 34a.

As described above, since the elastic member is disposed so as to cover the first and second guide shafts 14a and 34a, it is prevented that the elastic member gets out of between the first and second supporting parts 14 and 34.

Further, the resonance part 41 of the driving body is fixed to at the slider 30, as described later, and moved to be contacted with the outer circumferential surface of the lens holder 20, i.e., the contacting part 21.

More detailedly, the slider 30 is formed with a cylindrical fixing protrusion 32 which is fixedly inserted into the connecting part 45 of the resonance part 41.

The fixing protrusion 32 is formed at a center portion 45a of the slider 30 so as to be protruded in the direction orthogonal to the moving direction of the lens holder 20.

As described later, the slider 30 allows the actuating part 44 to be closely contacted with the sub-friction part 21a of the contacting part 21, such that the resonance part 41 is operated by being slid toward the contacting part 21 without separation from the slider 30.

Meanwhile, the driving body 40 of the present invention functions to push or pull the lens holder 20 upward and downward, i.e., in the optical axial direction, thereby actuating the lens holder 20.

Detailedly, the driving body 40 includes the resonance part 41, a first piezoelectric element 46 and a second piezoelectric element 47.

The resonance part 41 is formed of phosphor bronze and disposed slidably at the outer side surface of the base member 10, i.e., between the guide rails 11. One end of the resonance part 41 is contacted with the outer circumferential surface of the lens holder 20.

More detailedly, the resonance 41 part includes a first piezoelectric element coupling part 42, a second piezoelectric element coupling part 43, the actuating part 44, the connecting part 45 and the friction member 44a.

The first piezoelectric element coupling part 42 and the second piezoelectric element coupling part 43 are respectively formed into a flat shape which has a wider width in the direction orthogonal to the moving direction of the lens holder 20.

That is, the width of each opposite surface of the first and second piezoelectric element coupling parts 42 and 43 is formed to be wider in the direction orthogonal to the moving direction of the lens holder 20.

Unlike the embodiment of the present invention, if the first and second piezoelectric element coupling parts 42 and 43 have flat surfaces which are formed in parallel in the moving direction of the lens holder 20, it is difficult to work them due to their thin thickness, thereby deteriorating the durability thereof

Therefore, it is preferable that the first and second piezoelectric element coupling parts 42 and 43 are formed to have the flat surfaces which have the wider width in the direction orthogonal to the moving direction of the lens holder 20 according to the present invention, thereby facilitating machinability and assemblability thereof and also increasing productivity thereof.

The first and second piezoelectric element coupling parts 42 and 43 are disposed to be spaced apart from each other upward and downward. Also, the first and second piezoelectric element coupling parts 42 and 43 are disposed inclinedly so as to be gradually close to each other toward the actuating part 44, i.e., the contacting part 21.

That is, one end of the first piezoelectric element coupling part 42 and one end of the second piezoelectric element coupling part 43 are disposed to be close to each other, and the other end of the first piezoelectric element coupling part 42 and the other end of the second piezoelectric element coupling part 43 are disposed to be far away from each other.

The one end of the first piezoelectric element coupling part 42 and one end of the second piezoelectric element coupling part 43 which are close to each other are integrally connected with the actuating part 44.

Further, the first and second piezoelectric elements 46 and 47 are respectively installed at the first and second piezoelectric element coupling parts 42 and 43 so as to drive the actuating part 44.

In other words, the first and second piezoelectric element coupling parts 42 and 43 are contracted and expanded in their length direction by the first and second piezoelectric elements 46 and 47 so that the center portion 45a of the actuating part 44 performs an oval displacement motion.

As described above, since the first and second piezoelectric element coupling parts 42 and 43 are formed to be inclined toward the actuating part 44, a distance between the center portion 45a of the actuating part 44 and the one ends of the first and second piezoelectric element coupling parts 42 and 43 is minimized and thus driving force of the actuating part 44 is improved.

Further, the first and second piezoelectric element coupling parts 42 and 43 are symmetric with respect to an extension line between the actuating part 44 and the connecting part 45.

Since the connecting part 45 is disposed on a center line between the first and second piezoelectric element coupling parts 42 and 43, the first and second piezoelectric element coupling parts 42 and 43 can be operated in a balanced way.

One end of the actuating part 44 is connected to one end of the first piezoelectric element coupling part 42, and the other end thereof is connected to one end of the second piezoelectric element coupling part 43.

The center portion 45a of the actuating part 44 is formed to be protruded in an opposite direction of the first and second piezoelectric elements 46 and 47, i.e., toward the contacting part 21, and the friction member 44a contacted with the sub-friction part 21a is installed at the actuating part 44.

The friction member 44a is disposed at an upper side of the center portion 45a of the actuating part 44 so as to be contacted with the sub-friction part 21a installed at the connecting part 21 when the actuating part 44 is moved, thereby transmitting force for moving the lens holder 20 up and down.

As described above, since the sub-friction part 21 a is installed at the contacting part 21 and the friction member 44a contacted with the sub-friction part 21a is installed at the upper side of the center portion 45a of the actuating part 44, the friction force between the lens holder 20 and the actuating part 44 is increased and thus driving force of the actuating part 44 can be smoothly transmitted to the lens holder 20.

The connecting part 45 is disposed between the first and second piezoelectric element coupling parts 42 and 43 so as to connect the first and second piezoelectric element coupling parts 42 and 43 with each other.

More detailedly, the connecting part 45 includes the center portion 45a and an extended portion 45b.

The center portion 45a is formed inclinedly so that an up and down width of the center portion 45a is gradually reduced toward the actuating part 44. One end of the center portion 45a, which is located toward actuating part 44, is formed into an arc shape which is recessed toward the actuating part 44.

The other end of the center portion 45a is formed to be parallel with the moving direction of the lens holder 20 and surface-contacted with one end of the second supporting part 34.

The center portion 45a is fixedly coupled to the fixing protrusion 32 of the slider 30 and thus fixed to the slider 30 so as to be not rotated.

As described above, since the connecting part 45 is fixed to the slider 30 through the fixing protrusion 32, it is facile to assemble the resonance part 41.

The extended portion 45b is protruded from upper and lower ends of the center portion 45a to the first and second piezoelectric element coupling parts 42 and 43 and integrally connected to the first and second piezoelectric element coupling parts 42 and 43.

A thickness of the extended portion 45b corresponding to a moving direction of the slider 30 is thinner than that of the center portion 45a so as to be bent easily.

As described above, since the thickness of the of the extended portion 45b for connecting the center portion 45a and the first and second piezoelectric element coupling parts 42 and 43 is formed to be thin, it is minimized that the contracting and expanding of the first and second piezoelectric element coupling parts 42 and 43 are disturbed by the center portion 45a.

The first piezoelectric element 46 is formed into a square plate shape and installed on a wide upper surface of the first piezoelectric element coupling part 42.

The second piezoelectric element 47 is formed into a square plate shape and installed on a wide lower surface of the second piezoelectric element coupling part 43.

If necessary, the first piezoelectric element 46 may be installed on a lower surface of the first piezoelectric element coupling part 42, and the second piezoelectric element 47 may be installed on an upper surface of the second piezoelectric element coupling part 43.

And a first positive electrode is coupled to one surface of the first piezoelectric element 46, which is located between the first piezoelectric element 46 and the resonance part 41, and a first GND electrode is coupled to the other surface of the first piezoelectric element 46.

Further, a second positive electrode is coupled to one surface of the second piezoelectric element 47, which is located between the second piezoelectric element 47 and the resonance part 41, and a second GND electrode is coupled to the other surface of the second piezoelectric element 47.

Since the first positive electrode, the first GND electrode, the second positive electrode and the second GND electrode are thinly attached to the one surfaces and the other surfaces of the first and second piezoelectric elements 46 and 47, they are not designated by reference numerals.

Unlike the embodiment, the first GND electrode and the second GND electrode may be attached to the one surfaces of the first and second piezoelectric elements 46 and 47, and the first positive electrode and the second positive electrode may be attached to the other surfaces of the first and second piezoelectric elements 46 and 47.

And alternate voltage (AC voltage) of a proper frequency having a phase difference between the first and second electrodes is applied to the first and second piezoelectric elements 46 and 47, and thus the first and second piezoelectric elements 46 and 47 are contracted and expanded in a length direction of the resonance part 41 so as to drive the resonance part 41.

If the first and second piezoelectric elements 46 and 47 are contracted and expanded, the first and second piezoelectric element coupling parts 42 and 43 are also contracted and expanded in the length direction of the resonance part 41, and thus the actuating part 44 of the resonance part 41 performs the oval displacement motion.

Herein, it is preferable that the alternate voltage applied to each of the first and second positive electrodes has a phase difference of 90 degrees.

The control part functions to control the driving body 40. Detailedly, the control part controls the alternate voltage applied to the first and second piezoelectric elements 46 and 47 so that the driving body 40 is actuated so as to move the lens holder 20 up and down.

The control part applies the alternate voltage having a frequency corresponding to the proper frequency of the driving body 40 and a phase difference of 90 degrees to each of the first and second positive electrodes, such that the actuating part 44 located at the other end of the resonance part 41 drives the lens holder 20 in the optical axial direction while performing the oval displacement motion.

FIGS. 8 to 10 are to explain the motion of the actuating part 44 by the driving body 40 and show a motion state of the resonance part 41.

As shown in FIG. 8, the other end of the resonance, i.e., the actuating part 44 is reciprocated in a length direction thereof by alternate voltage of a first resonance frequency applied to the first and second piezoelectric elements 46 and 47.

As shown in FIG. 9, the actuating part 44 is reciprocated up and down in a vertical direction of the length direction thereof by alternate voltage of a second resonance frequency applied to the first and second piezoelectric elements 46 and 47.

Herein, the first and second piezoelectric element coupling parts 42 and 43 are contracted and expanded equally by the first resonance frequency.

That is, the first and second piezoelectric element coupling parts 42 and 43 are contracted and expanded equally while having the almost same phase difference.

And the first and second piezoelectric element coupling parts 42 and 43 are contracted and expanded alternately by the second resonance frequency.

That is, while the first and second piezoelectric element coupling parts 42 and 43 have the opposite phase differences, the second piezoelectric element coupling part 43 is contacted when the first piezoelectric element coupling part 42 is expanded.

The control part applies alternate voltage having a proper frequency between the first and second resonance frequencies to the first and second piezoelectric elements 46 and 47 such that the actuating part 44 located at the other end of the resonance part 41 drives the lens holder 20 in the optical axial direction while performing the oval displacement motion.

Preferably, the proper frequency is a frequency having a ½ value of the sum of the first and second resonance frequencies, and the second resonance frequency has a value between the first resonance frequency and a first anti-resonance frequency.

As described above, since the alternate voltage having the phase difference of 90 degrees and the proper frequency is applied to the first and second piezoelectric elements 46 and 47, the actuating part 44 performs the oval displacement motion (FIG. 10) by the length directional movement (FIG. 8) due to the first resonance frequency and the up and down movement (FIG. 9).

Hereinafter, the operation of the present invention as described above will be described.

The control part applies the alternate voltage having the phase difference of 90 degrees to each of the first and second positive electrodes connected to the first and second piezoelectric elements 46 and 47.

That is, the alternate voltage applied to each of the first and second piezoelectric elements 46 and 47 has the phase difference of 90 degrees.

Herein, the alternate voltage has the proper frequency corresponding to an intermediate value between the first and second resonance frequencies.

If the alternate voltage of the proper frequency having the phase difference of 90 degrees is applied to each of the first and second positive electrodes, the first and second piezoelectric elements 46 and 47 are contracted and expanded respectively, and thus the first and second piezoelectric element coupling parts 42 and 43 connected with the first and second piezoelectric elements 46 and 47 are moved and the resonance part 41 is actuated finally.

Herein, since the frequency of the applied alternate voltage is the proper frequency between the first and second resonance frequencies of the driving body 40, the driving body 40, detailedly, the resonance part 41 can be actuated with small force.

Meanwhile, the actuating part 44 is reciprocated in the length direction thereof by the first resonance frequency, as shown in FIG. 8, and also the actuating part 44 is reciprocated up and down by the second resonance frequency, as shown in FIG. 9.

At this time, since the center portion 45a of the connecting part 45a is fixed to the slider 30, it is in a stationary state. The extended portion 45b is bent according to a contracting and expanding direction of the first and second piezoelectric element coupling parts 42 and 43 so that the first and second piezoelectric element coupling parts 42 and 43 can be facilely contracted and expanded.

In case that the first resonance frequency which allows the actuating part 44 to be reciprocated in the length direction is 364kHz and the second resonance frequency which allows the actuating part 44 to be reciprocated up and down is 366kHz, the control parts applies a proper frequency of 365 kHz as an average value of the first and second resonance frequencies to the first and second piezoelectric elements 46 and 47.

Then, as shown in FIG. 10, since a vibration mode in the length direction and a vibration mode in the up and down direction are combined, the actuating part 44 performs the oval motion.

As described above, if the alternate voltage is applied, the friction member 44a coupled to the other end of the actuating part 44 performs the oval motion along a tracking path designated by a dotted line, as shown in FIG. 10.

Meanwhile, when a difference value between the first and second resonance frequencies is large, a difference value between the proper frequency and the first and second resonance frequencies is also large. Therefore, even though the alternate voltage having the proper frequency is applied to the actuating part 44, the actuating part 44 may not perform the oval motion.

Since the actuating part 44 performs the oval displacement motion, the friction member 44a coupled to the actuating part 44 is contacted with the sub-friction part 21a installed at the lens holder 20 so as to push up or down the lens holder 20 so that the lens holder 20 can be moved in the optical axial direction.

Since the slider 30 is elastically supported toward the sub-friction part 21a by the elastic member and the resonance part 41 is fixed to the slider 30 through the connecting part 45 and also biased toward the sub-friction part 21a, the friction member 44a coupled to the actuating part 44 is tightly contacted with the sub-friction part 21a installed at the lens holder 20.

Further, since the first and second piezoelectric element coupling parts 42 and 43 are formed inclinedly to be gradually close to each other toward the actuating part 44, and one ends of the first and second piezoelectric element coupling parts 42 and 43 are disposed to be adjacent to the friction member 44a, the driving force of the actuating part 44 is enhanced.

### INDUSTRIAL APPLICABILITY

As described above, the present invention can be installed at a compact camera so as to drive the lens holder up and down, thereby facilely moving the lens.

While the present invention has been described with respect to the specific embodiments, it will be apparent to those skilled in the art that various changes and modifications may be made without departing from the spirit and scope of the invention as defined in the following claims.

1. A driving body having a piezoelectric element mounted thereon, comprising:
a resonance part;
a first piezoelectric element and a second piezoelectric element which are coupled with the resonance part so as to actuate the resonance part;
a first positive electrode and a second GND electrode of which one is coupled to one surface of the first piezoelectric element between the first piezoelectric element and the resonance part and the other one is coupled to the other surface of the first piezoelectric element; and a second positive electrode and a second GND electrode of which one is coupled to one surface of the second piezoelectric element between the second piezoelectric element and the resonance part and the other one is coupled to the other surface of the second piezoelectric element,
wherein alternate voltage of a proper frequency having a phase difference is applied to each of the first and second positive electrodes so as to driving the resonance part, and
the resonance part comprises a first piezoelectric element coupling part in which the first piezoelectric element is installed; a second piezoelectric element coupling part in which the second piezoelectric element is installed; and an actuating part of which one end is connected to the first piezoelectric element coupling part, the other end is connected to the second piezoelectric element coupling part and a center portion performs an oval displacement motion by the first and second piezoelectric elements, and
the first and second piezoelectric element coupling parts are inclinedly formed so as to be gradually close to each other toward the actuating part, and
the first and second piezoelectric elements are inclinedly installed at the first and second piezoelectric element coupling parts so as to be gradually close to each other toward the actuating part.

2. The driving body according to claim 1, wherein, when the alternate voltage of the proper frequency is applied, the first and second piezoelectric element coupling parts are contracted and expanded by the first and second piezoelectric elements so as to have a phase difference in a length direction of the resonance part, such that the actuating part of the resonance part performs the oval displacement motion, and
the first and second piezoelectric element coupling parts are formed into a flat surface shape which has a wide width in a direction orthogonal to a contracting and expanding direction thereof, and
the first piezoelectric element is installed at one of upper and lower surfaces of the first and second piezoelectric element coupling parts having the wide width, and
the second piezoelectric element is installed at one of the upper and lower surfaces of the first and second piezoelectric element coupling parts having the wide width.

3. The driving body according to claim 2, wherein a connecting part is formed between the first and second piezoelectric element coupling parts so as to connect the first and second piezoelectric element coupling parts, and
the first and second piezoelectric element coupling parts are symmetric with respect to an extension line between the actuating part and the connecting part.

4. The driving body according to any one of claims 1 to 3, wherein the proper frequency of the alternate voltage applied to the first and second positive electrodes is a value between a first resonance frequency by which the actuating part is reciprocated in a length direction of the resonance part and a second resonance frequency by which the actuating part performs a curvature movement in a direction vertical to the length direction of the resonance part.

5. The driving body according to claim 4, wherein the second resonance frequency has a value between the first resonance frequency and a first anti-resonance frequency.

6. A driving device for a compact camera using a piezoelectric element, comprising:
a base member;
a lens holder which is disposed in the base member and in which a lens is installed to be driven in an optical axial direction;
a driving body which drives the lens holder in the optical axial direction; and
a control part which controls the driving body,
wherein the driving body comprises a resonance part which is slidably disposed at a side surface of the base member and of which one end is contacted with an outer circumferential surface of the lens holder; a first piezoelectric element and a second piezoelectric element which are coupled with the resonance part so as to actuate the resonance part;
a first positive electrode and a first GND electrode of which one is coupled to one surface of the first piezoelectric element between the first piezoelectric element and the resonance part and the other one is coupled to the other surface of the first piezoelectric element; and a second positive electrode and a second GND electrode of which one is coupled to one surface of the second piezoelectric element between the second piezoelectric element and the resonance part and the other one is coupled to the other surface of the second piezoelectric element, and
the resonance part comprises a first piezoelectric element coupling part in which the first piezoelectric element is installed; a second piezoelectric element coupling part in which the second piezoelectric element is installed; and an actuating part of which one end is connected to the first piezoelectric element coupling part, the other end is connected to the second piezoelectric element coupling part and a center portion is contacted with the outer circumferential surface of the lens holder, and
the control part applies alternate voltage having a frequency corresponding to a resonance frequency of the driving body and having a phase difference to each of the first and second positive electrodes, and
the actuating part is reciprocated in a length direction by alternate voltage of a first resonance frequency applied to the first and second piezoelectric elements and also performs a curvature movement in a direction vertical to the length direction by a second resonance frequency applied to the first and second piezoelectric elements, and
the control part applies alternate voltage having a proper frequency between the first and second resonance frequencies to the first and second piezoelectric elements, such that a center portion of the actuating part performs an oval motion and also drives the lens holder in an optical axial direction, and
the first and second piezoelectric element coupling parts are inclinedly formed so as to be gradually close to each other toward the actuating part, and
the first and second piezoelectric elements are inclinedly installed at the first and second piezoelectric element coupling parts so as to be gradually close to each other toward the actuating part.

7. The driving device according to claim 6, wherein the first and second piezoelectric element coupling parts are formed into a flat surface shape which has a wide width in a direction vertical to a moving direction of the lens holder, and
the first piezoelectric element is installed at one of upper and lower surfaces of the first piezoelectric element coupling part having the wide width, and
the second piezoelectric element is installed at one of the upper and lower surfaces of the second piezoelectric element coupling part having the wide width.

8. The driving device according to claim 6 or 7, further comprising a slider which is installed at the base member so as to be slid toward the outer circumferential surface of the lens holder; and an elastic member which elastically supports the slider toward the outer circumferential surface of the lens holder,
wherein the resonance part is installed at the slider so as to move the actuating part, so that the actuating part is contacted with the outer circumferential surface of the lens holder.

9. The driving device according to claim 8, wherein a connecting part is formed between the first and second piezoelectric element coupling parts so as to connect the first and second piezoelectric element coupling parts, and
a fixing protrusion which is fixedly inserted into the connecting part is formed at the slider.

10. The driving device according to claim 9, wherein the connecting part is disposed between the first and second piezoelectric element coupling parts and comprises a center portion in which the fixing protrusion is fixedly inserted; an extended portion which is protruded from the center portion to the first and second piezoelectric element coupling parts so as to be integrally connected with the first and second piezoelectric element coupling parts, and
a thickness of the extended portion in a moving direction of the slider is thinner than that of the center portion.

11. The driving device according to claim 9, wherein the first and second piezoelectric element coupling parts are symmetric with respect to an extension line between the actuating part and the connecting part.

12. The driving device according to claim 9, wherein guide rails are formed at a side surface of the base member so as to be spaced apart from each other upward and downward, and
guide grooves are formed in the guide rails so as to be oppositely opened, and
a guide protrusion is formed at upper and lower ends of the slider to be bent in a direction orthogonal to the moving direction of the lens holder, and
the guide protrusion is inserted into the guide grooves.

13. The driving device according to claim 12, wherein a first supporting part is formed at an opposite side of the actuating part with the connecting part in the center so as to be protruded from the side surface of the base member, and a second supporting part of which one end is contacted with the connecting part is formed at the slider so as to be protruded between the first supporting part and the connecting part, and
the elastic member is disposed between the first and second supporting parts so as to elastically support the slider toward the outer circumferential surface of the lens holder.

14. The driving device according to claim 13, wherein a first guide shaft is formed at the first supporting part so as to be protruded to the second supporting part, and
a second guide shaft is formed at the other end of the second supporting part so as to be protruded to the first supporting part, and
the elastic member is disposed to cover the first and second guide shafts.

15. The driving device according to claim 6 or 7, wherein a contacting part is formed at the outer circumferential surface of the lens holder so as to be protruded toward the actuating part, and
a friction member is formed at a center portion of the actuating part so as to be protruded in an opposite direction of the first and second piezoelectric elements, and
a sub-friction part contacted with the friction member is installed at the contacting part.

16. The driving device according to claim 6 or 7, wherein a movement guide member is disposed between the base member and the lens holder so as to smoothly move the lens holder up and down, and
the movement guide member comprises a retainer which is disposed between the base member and the lens holder, and a ball member which is rotatably inserted into the retainer so as to be contacted with the side part and the lens holder.
